(19) United States
(12) Patent Application Publication
(10) Pub. No.: US 2007/0036433 A1
(43) Pub. Date: Feb. 15, 2007

(54) Recognizing data conforming to a rule

(75) Inventors: Brian C. Teutsch, Seattle, WA (US); Willson Kulandai-Raj David, Woodinville, WA (US); Joshua S. Bell, Kirkland, WA (US); Aleksandr Tsybert, Redmond, WA (US); Laurent Mollicone, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/203,818

(22) Filed: Aug. 15, 2005

(51) Int. Cl. G06K 9/34; G06F 17/00

(52) U.S. Cl. 382/173; 715/505; 715/507

(57) ABSTRACT

Systems and/or methods (“tools”) are described that enable a recognition system to recognize user-entered data conforming to a data rule. The tools may do so by providing data regions for a document. With these data regions, the recognition system may better determine what information on the document is user-entered and what is not. Each of these data regions has a data rule governing data for that region. With the data rule, the recognition system may better recognize data from each region. The tools may ascertain these data regions and rules from an electronic form having controls laid out similarly to data-entry areas of the document.

### BACKGROUND

Even with the proliferation of electronic forms, many companies still use paper forms. Companies recognize that users often do not have easy access to a computer and so give users a paper form to fill out. Once the form is filled out, companies often want to store the user-entered data electronically. To store this user-entered data, another person can read the paper form and type the data into a computer. But this is time consuming and tedious.

Some computer programs, such as optical character recognition (OCR) programs, are designed to recognize user-entered data on a form. A computer program can be written specifically for a particular paper form but this requires software programming, which can be expensive and time consuming. Other programs may be more generic, and so are not custom made for each paper form, but these programs often fail to accurately recognize user-entered data.

### SUMMARY

Systems and/or methods (“tools”) are described that enable a recognition system to recognize user-entered data conforming to a data rule. The tools may do so by providing data regions for a document. With these data regions, the recognition system may better determine what information on the document is user-entered and what is not. Each of these data regions has a data rule governing data for that region. With the data rule, the recognition system may better recognize data from each region. The tools may ascertain these data regions and rules from an electronic form having controls laid out similarly to data-entry areas of the document.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an exemplary operating environment in which various embodiments can operate.

FIG. 2 illustrates an exemplary printed document with user-entry areas.

FIG. 3 illustrates an exemplary electronic form having controls with a layout similar to that of the user-entry areas of the document shown in FIG. 2.

FIG. 4 is an exemplary process for enumerating data regions and data rules.

FIG. 5 is an exemplary process for enabling a recognition system to recognize data conforming to a data rule and for performing this recognition.

The same numbers are used throughout the disclosure and figures to reference like components and features.

### DETAILED DESCRIPTION

Overview

Systems and/or methods (“tools”) are described that enable a recognition system to recognize user-entered data conforming to a data rule. The tools provide data regions with corresponding data rules to a recognition system. These regions and rules may be based on controls of an electronic form having a two-dimensional layout similar to the layout of data-entry areas of a document having user-entered data.

In some cases a user builds the electronic form based on the document, after which the tools ascertain two-dimensional regions of the electronic form that are of interest, as well as data rules for data in these regions. The tools can send these regions and rules to a recognition system, which enables the system to differentiate between user-entered and default data, as well as better recognize the user-entered data in these regions.

Exemplary Operating Environment

Before describing the tools in detail, the following discussion of an exemplary operating environment is provided to assist the reader in understanding where and how the tools may be employed. The description provided below constitutes but one example and is not intended to limit application of the tools to any one particular operating environment.

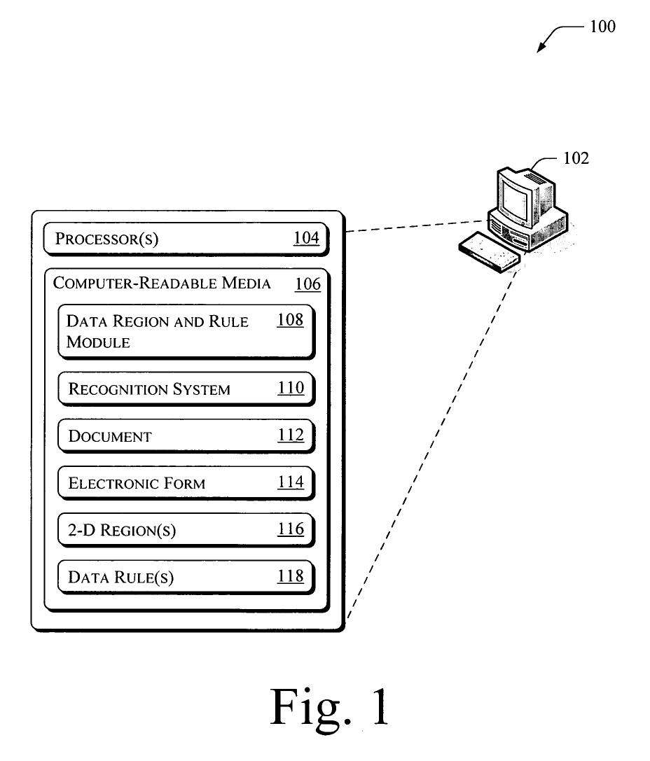

FIG. 1 illustrates one such operating environment generally at 100 comprising a computer 102 having one or more processors 104 and computer-readable media 106. The processors are capable of accessing and/or executing the computer-readable media. The computer-readable media comprises or has access to a data region and rule module 108 capable of enabling a recognition system 110 to recognize data conforming to a data rule. The recognition system extracts information from documents, such as with an optical character recognition process. The recognition system is capable of extracting information and retaining a location on a document from where the information was extracted or of extracting information at a particular location and retaining or forwarding the extracted information. This system may be document-generic, thereby being capable of extracting information from arbitrary documents, such as those having different layouts of user-entry areas. The recognition system and document are shown as part of the computer-readable media, though they may also be separate from the computer-readable media or the computer. Document 112 comprises user-entered data where a two-dimensional area for the user-entered data is discoverable. The document may be printed or electronic.

Operating environment 100 also comprises an electronic form 114. This electronic form has controls (e.g., data-entry fields) oriented in two-dimensions similarly to document 112's layout of areas in which user-entered data may reside. The electronic form may be created based on document 112 or a similar document. Or, it may be the source of the document, such as when the electronic form is printed and a user types or writes data onto the printed version of the electronic form resulting in a printed document having user-entered data.

Two-dimensional regions 116 and corresponding data rules 118 are also shown. In one embodiment described below, these regions and rules are ascertained from the electronic form by the data region and rule module.

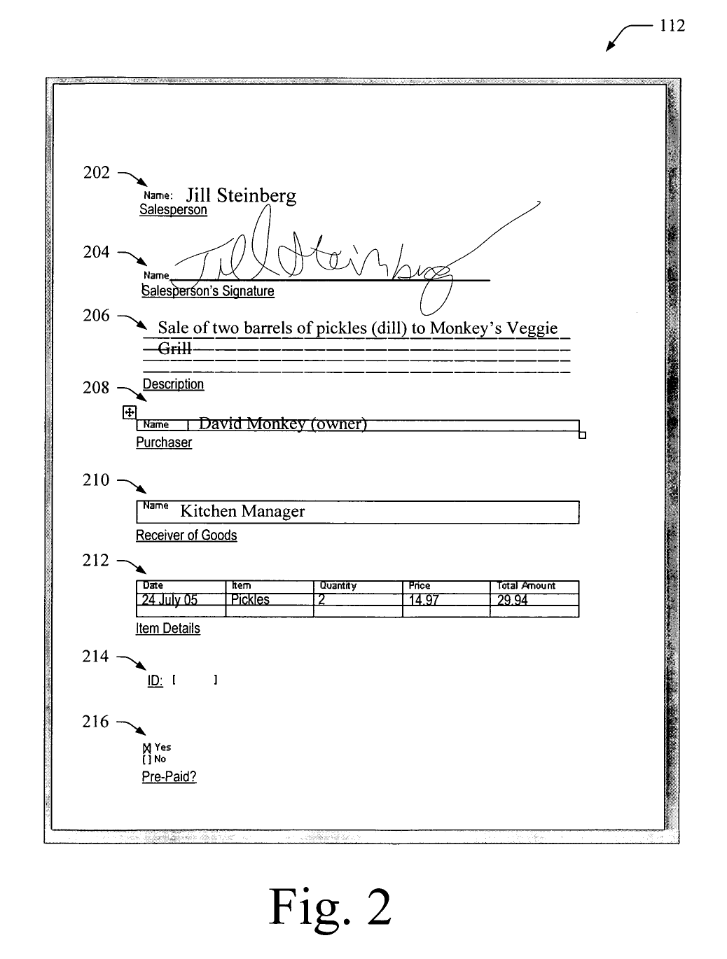

An exemplary printed document 112 is illustrated in FIG. 2. This printed page shows how a document may have areas intended for user entry, text that is not user-entered (e.g., “Name”), and both typed and written user-entered data.

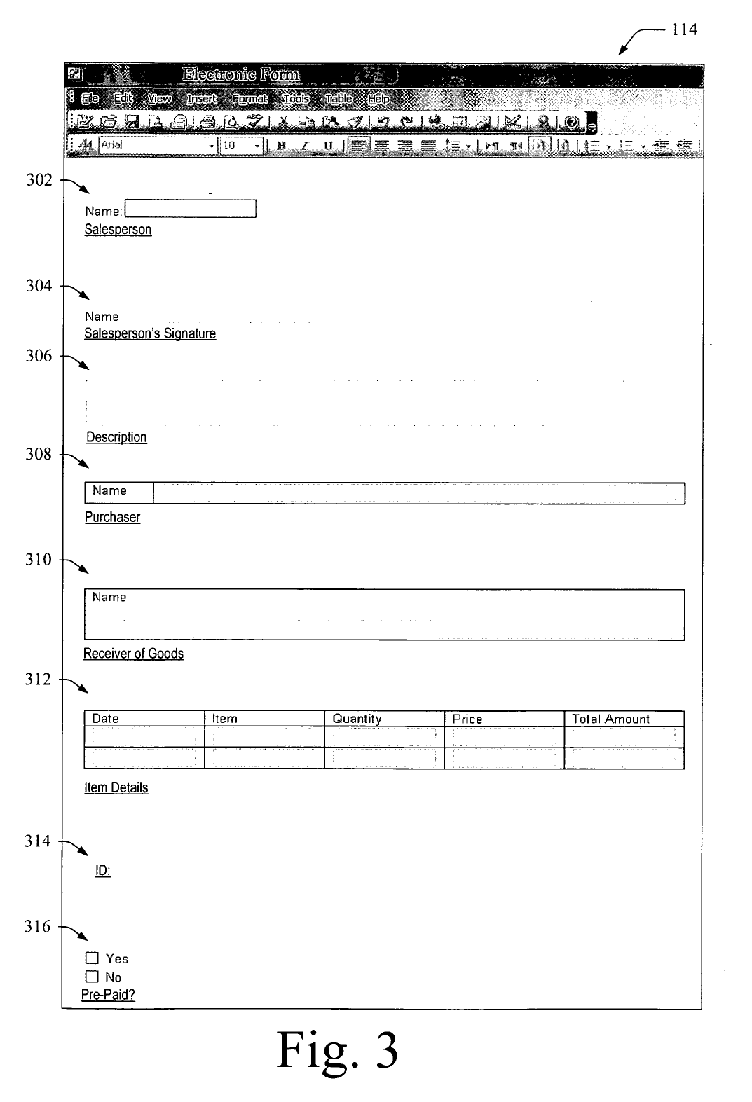

An exemplary electronic form 114 is illustrated in FIG. 3. This electronic form has controls with a two-dimensional layout on the electronic form similar to that of the user-entry areas shown in document 112. The document and electronic form are illustrated to give the reader context for one of the ways in which the tools may enable the recognition system to recognize data conforming to a data rule. They are described in greater detail below.

Enumerating Data Regions and Data Rules

The following discussion describes exemplary ways in which the tools enumerate data regions and data rules.

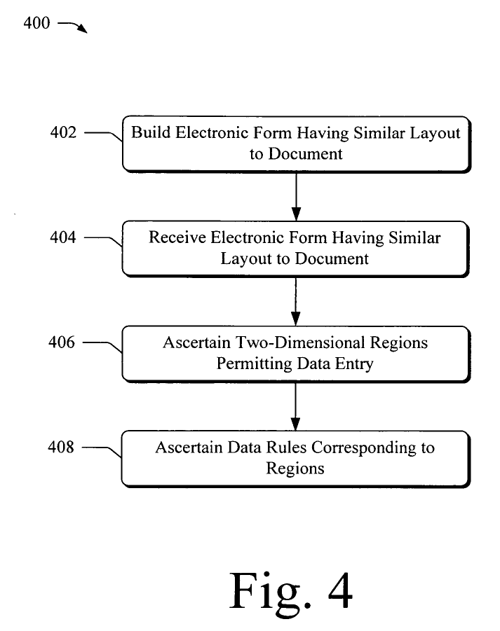

FIG. 4 is an exemplary process 400 for enumerating data regions and rules. It is illustrated as a series of blocks representing individual operations or acts performed by elements of the operating environment 100 of FIG. 1, such as data region and data rule module 108. This and other processes disclosed herein may be implemented in any suitable hardware, software, firmware, or combination thereof; in the case of software and firmware, these processes represent a set of operations implemented as computer-executable instructions stored in computer-readable media 106 and executable by processor(s) 104.

Block 402 builds an electronic form having a layout of controls oriented in two dimensions similarly to a layout of user-entry areas of a document, such as a printed document intended to be analyzed by a recognition system. This electronic form may be built automatically or with a person's interaction. In some cases, for instance, a blank version of the document to be analyzed is used to build an electronic form automatically. An application can recognize data-entry fields in the document and assign a position to these fields, infer or assign data rules (e.g., schema) governing these fields, and build the electronic form based on these data-entry fields and their inferred rules.

In some other cases a person builds the electronic form. In the illustrated embodiment a user studies document 112 in FIG. 2 to determine areas of the document that are intended for a user's entry and data rules implicitly or explicitly required for that entry. For example, a person can study a portion of document 112 marked at 202. This portion indicates that the document intends a person to enter his or her name, that the person is probably a salesperson, that the text “Name:” and “Salesperson” are not user-entered data, and that the data entered is implicitly intended to be a string of non-numerical characters. Also, that an area about to the right of “Name:” is intended for entry by a user of his or her name. Based on this information, a person can build (e.g., with an application capable of building an electronic form having regions and rules, like Microsoft® InfoPath™) a portion of an electronic form having a control with a two-dimensional region mappable to the user-entry area and having a data rule requiring that the user-entered data be a string of non-numerical text.

FIG. 3 shows a visual representation of this control at 302. Here a person has added a control with a layout oriented similarly to the user-entry area of the document at 202, also with the “Name:” and “Salesperson” text. The control is also built to have a schema permitting data within a certain two-dimensional region (marked by the box after “Name:”) that is a non-numerical string of characters.

FIGS. 2 and 3 are also illustrated with other data-entry areas and corresponding controls, respectively. Using a similar analysis, a person can build the electronic form to have the following: a data-entry field at 304 corresponding to a signature user-entry area at 204 and permitting only non-numerical characters; a rich-text data-entry field 306 corresponding to a description user-entry area 206 and permitting rich text with number, letters, and symbols; a data-entry field at 308 corresponding to a purchaser user-entry area 208 and permitting a string of non-numerical characters; another data-entry field at 310 corresponding to a receiver of goods user-entry area 210 and permitting a string of non-numerical text; a table at 312 corresponding to an item details user-entry area 212 and permitting a date only in the first column, a string of text in the second column, an integer in the third column, a number in the fourth column, and another number in the fifth column. This table 312 can also have data rules permitting only a certain number of characters. The electronic form also has a data-entry field at 314 corresponding to a user identification user-entry area 214 and permitting a number having exactly six characters, and a radio-button control at 316 corresponding to a pre-paid user-entry area at 216.

The electronic form, whether the source of the document or built based on the document, has controls with two-dimensional regions having a layout similar to that of user-entry areas of the document. These controls also have associated rules, such as those mentioned above, and may have others, such as those requiring certain patterns (like social security numbers, postal codes, phone numbers, etc.) or user-specified restrictions.

Block 404 receives an electronic form having a similar layout to that of a document. The electronic form shown in FIG. 3 has controls in a similar layout and corresponding rules for those controls. It can be built as described at block 402, built in another manner, such as from a third party source, or be a source for the document, such as when the document is a printed and filled-in copy of the electronic form.

Block 406 ascertains, based on a two-dimensional layout of an electronic form, two-dimensional regions 116 of the electronic form permitting entry of data. The electronic form has a layout similar to that of the document, thereby permitting the two-dimensional regions to map to user-entry areas of the document. Block 406 can determine these two-dimensional regions based on view information of the electronic form.

Here electronic form 114 has view information written in HyperText Markup Language (HTML). The electronic form's schema (written in eXtensible Markup Language (XML)) is transformed based on the electronic form's transform (written in XML Stylesheet Language (XSL)). Transforming the schema with the XSL results in the HTML view information. This view information has view-oriented (e.g., two-dimensional layout) information that data region and rule module 108 analyzes. Module 108 can parse the HTML to find two-dimensional regions 116 shown in FIG. 1 that are in the electronic form and are intended for entry of data.

The module can determine the exact coordinates bounding the portion of the control permitting or intended for a user's data entry, such as the controls shown in FIG. 3. But these controls may have slightly different sizes or orientations as those of a printed document or its electronic visual rendering. For this reason, the module may also build sets of two-dimensional regions for both a printed version and an electronic visual rendering (e.g., electronic 2-D view). A printed page, for instance, can have page breaks that interfere or break up a data region. A two-dimensional region could begin at the end of one page and continue on the next. To address this, the module can build sets of coordinates for the two-dimensional regions based on the size of the page (e.g., A4 or 8½ by 11 inches) on which they are printed. The module can also build in a fudge factor, as a printed page may be slighted canted or otherwise misaligned.

Block 406 may also build a set of two-dimensional regions for an electronic rendering. For an electronic 2-D view, the two-dimensional regions may be arranged in the view differently than a printed version—such as is shown in the difference between the layout of FIG. 2 and FIG. 3. FIG. 2 shows a whole printed page. FIG. 3 shows an electronic rendering with some of the margins of the rendered page truncated.

Block 408 ascertains data rules corresponding to two-dimensional regions of the electronic form. These data rules (e.g., data rules 118 of FIG. 1) may comprises any of those described above, such as limitations on the type of text that may be received or what a user may select (e.g., one radio button of a set of radio buttons).

Here module 108 ascertains data rules 118 based on the electronic form's schema. Each of the controls of the electronic form has corresponding two-dimensional regions 116. Each of the controls is also governed by a portion of the schema of the electronic form. Based on the portion of the schema governing a particular control, module 108 can ascertain the data rule(s) for that control, and thus correspond a data rule to the two-dimensional region for that control.

Enabling Recognition of and Recognizing Data

The following discussion describes exemplary ways in which the tools enable a recognition system to recognize data conforming to a data rule. In the process described below, the tools enable this recognition with data regions and data rules. This process also describes ways in which the recognition system may recognize data based on these regions and rules.

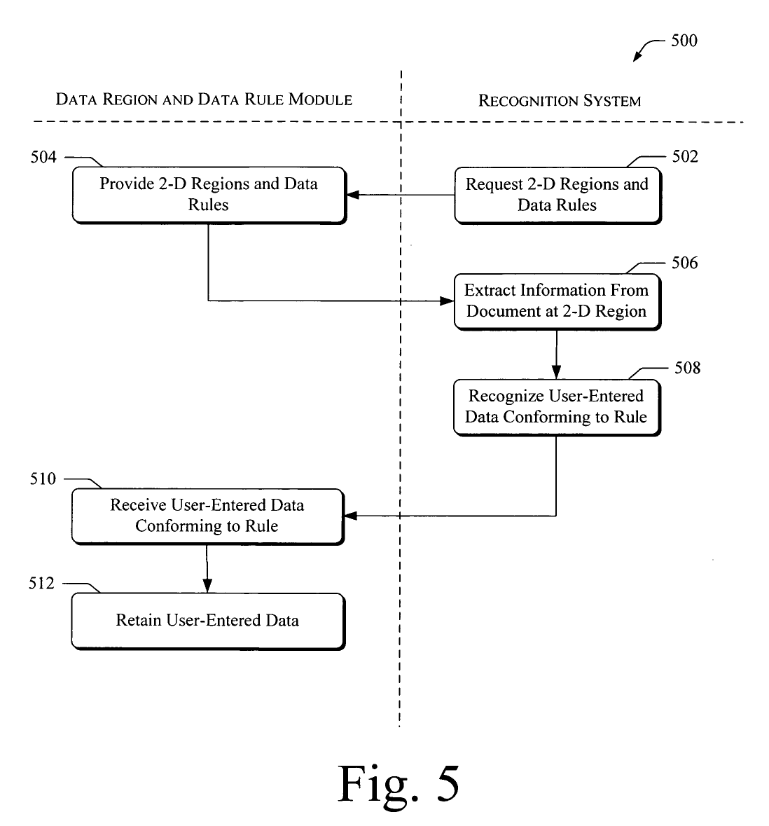

FIG. 5 shows an exemplary process 500 illustrated as a series of blocks representing individual operations or acts performed by the tools, such as data region and rule module 108 and recognition system 110.

Block 502 requests two-dimensional regions and corresponding data rules. Here recognition system 110 requests these regions and rules from module 108 using a publicly-accessible Application Program Interface (API). The requested regions and rules are for a particular type of document, thereby indicating what regions and rules are appropriate. The recognition system may have determined the two-dimensional format of the document, such as whether it is an electronic rendering or printed on a page (e.g., on 8½×11 paper). In this case the recognition system may request a particular set of two-dimensional regions appropriate to the two-dimensional format.

Block 504 provides two-dimensional regions and corresponding data rules to a recognition system. These regions and rules may be provided in a programmatically accessible enumeration of controls of an electronic form, such as those of electronic form 114.

Here module 108 either sends multiple sets of data regions, such as those appropriate to multiple two-dimensional formats for a document, or a particular set of data regions if the format is known. Each data rule or rules for a region may enable the recognition system to recognize user-entered data on the document that conforms to the data rule. The data region may also enable the recognition system to differentiate between various pieces of information extracted, or what to extract, from the document.

For example, the data region may indicate what information on the document is important (e.g., user-entered data) and what is not. Referring back to FIG. 2 at 202, the data region may indicate to the recognition system that “Name:” information is not user-entered data but that “Jill Steinberg” information is user-entered data. Based on this, the recognition system may either differentiate between user-entered and default information extracted from the document (e.g., all text of the document) or extract the user-entered data located at the two-dimensional region.

The data rule enables the recognition system to extract user-entered data conforming to the data rule. This can help the recognition system to correctly recognize user-entered data. For example, assume that the recognition system determines that the typed data at 202 (“Jill Steinberg”) is user-entered data based on its two-dimension location on the page. Assume also that the recognition system does not know whether or not this user-entered data should be “Jill Steinberg” or “1111 St Einberg”. If the data rule indicates that the data should be a street address, the recognition system may recognize the data as “1111 St. Einberg”. Instead, the data rule indicates that the data must be a string of non-numerical characters. Because of the rule, the recognition system may recognize the data correctly as “Jill Steinberg”.

Block 506 extracts information from a document at two-dimensional regions on the document. Block 506 can extract information at the received two-dimensional regions or extract information and then differentiate between information at the two-dimensional region and other information. Here the recognition system extracts all of the text of document 112 shown in FIG. 2 using an optical character recognition process and retains the location on the document from which the pieces of text (or other information) are extracted. Following this, the recognition system differentiates the information based on its retained location matching the received two-dimensional regions. This results in information that is likely user-entered data, though how it should be recognized is not necessarily known.

Block 508 recognizes user-entered data conforming to a data rule. The recognition system recognizes data conforming to a rule corresponding to its two-dimensional region. In the illustrated embodiment, the recognition system correctly recognizes the following user-entered data for document 112 of FIG. 2:
Jill Steinberg
Jill Steinberg
Sale of two barrels of pickles (dill) to Monkey's Veggie Grill
David Monkey (owner)
Kitchen Manager
24 Jul. 2005, Pickles, 2, 14.97, and 29.94
(a blank space)
X, Yes, or check

Block 510 receives user-entered data conforming to a data rule. Here module 108 receives the above-listed user-entered data. The module may also receive an indication of the control (e.g., the two-dimensional location or a data rule identifier) to which the recognized data belongs. Thus, the module can receive “Jill Steinberg” and an indication that it is associated with control 302 of FIG. 3.

Block 512 retains user-entered data. The module can retain the user-entered data in a database or in a more structured format. In some cases the module retains the data in the corresponding node of a data instance for electronic form 114. In this illustrated embodiment, the module may build a data instance for the electronic form having the following data correctly conforming to its required data rule:
“Jill Steinberg” in data-entry field 302;
“Jill Steinberg” in data-entry field 304;
“Sale of two barrels of pickles (dill) to Monkey's Veggie Grill” in rich-text data-entry field 306;
“David Monkey (owner)” in data-entry field 308;
“Kitchen Manager” in data-entry field 310;
“24 Jul. 2005”, “Pickles”, “2”,“14.97”, and “29.94” in cells of table 312;
“ ” (a blank space) in data-entry field 314; and
“X”, “Yes”, or “check” in the “Yes” radio-button control 316.

Conclusion

The above-described systems and methods enable recognition systems to recognize user-entered data on a document conforming to a data rule. This permits the recognition system to extract and recognize data from many different types of documents. Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

1. One or more computer-readable media having computer-readable instructions therein that, when executed by a computer, cause the computer to perform acts comprising:
providing a two-dimensional region to a recognition system, the recognition system capable of extracting information from a document at the two-dimensional region; and
providing a data rule to the recognition system, the data rule corresponding to the two-dimensional region and enabling the recognition system to recognize, from information extracted from the document at the two-dimensional region, user-entered data on the document that conforms to the data rule.

2. The media of claim 1, wherein the recognition system comprises an optical character recognition software application.

3. The media of claim 1, wherein the two-dimensional region comprises position information mappable to a printed version of the document.

4. The media of claim 1, wherein:
the act of providing the two-dimension region provides multiple two-dimension regions;
the recognition system is capable of correlating a portion of a body of information extracted from the document with one of the multiple two-dimensional regions resulting in a correlated two-dimensional region and a correlated portion of the body of information; and
the act of providing the data rule provides the data rule corresponding to the correlated two-dimensional region thereby enabling the recognition system to recognize, from the correlated portion of the body of information, user-entered data on the document that conforms to the data rule corresponding to the correlated two-dimensional region.

5. The media of claim 1, further comprising generating the two-dimensional region and the data rule using an electronic form having a layout of controls oriented in two-dimensions similarly to a layout of user-entry areas of the document.

6. The media of claim 1, wherein the data rule requires non-numerical text.

7. The media of claim 1, wherein the recognition system is capable of extracting information from documents having an arbitrary layout of user-entry areas.

8. The media of claim 1, further comprising receiving user-entered data conforming to the data rule and storing the user-entered data in an instance of an electronic form.

9. A method comprising:
ascertaining a two-dimensional region of an electronic form permitting entry of data;
ascertaining one or more data rules corresponding to the two-dimensional region; and
providing the two-dimensional region and the one or more data rules effective to enable a recognition system to recognize user-entered data on a document at the two-dimensional region and conforming to the one or more data rules.

10. The method of claim 9, wherein the act of ascertaining the two-dimensional region ascertains two-dimensional coordinates bounding a control of the electronic form.

11. The method of claim 9, wherein the act of ascertaining the two-dimensional region parses a HyperText Machine Language (HTML) rendering of the electronic form.

12. The method of claim 9, wherein the act of ascertaining data rules analyzes a portion of a schema for the electronic form, the portion governing a control associated with the two-dimensional region.

13. The method of claim 9, wherein the data rules limit a type or length of text permitted in the two-dimensional region.

14. The method of claim 9, wherein the electronic form is the source of the document.

15. The method of claim 9, wherein the two-dimensional region is designed for handwritten or type-written entry of data.

16. The method of claim 9, further comprising building the electronic form based on the document, the electronic form built to have: controls with a two-dimensional layout similar to that of user-entry areas of the document; and data rules associated with the controls and requiring user-entered data of a type that the document implicitly or explicitly requires.

17. A method comprising:
extracting information from a two-dimensional document to provide extracted information;
differentiating the extracted information based on a two-dimensional region of the document to provided differentiated extracted information from the two-dimensional region and other extracted information not from the two-dimensional region; and
recognizing, from the differentiated extracted information, user-entered data conforming to a data rule, the data rule corresponding to the two-dimensional region.

18. The method of claim 17, further comprising receiving the two-dimensional region and the data rule.

19. The method of claim 17, wherein the two-dimensional region and the data rule are ascertained from a control of an electronic form, the electronic form having a two-dimensional layout of controls mappable to user-entry areas of the document.

20. The method of claim 19, further comprising providing the user-entered data effective to enable the user-entered data to be stored in an instance of the electronic form.
